(19) United States
(12) Patent Application Publication
(10) Pub. No.: US 2024/0035829 A1
(43) Pub. Date: Feb. 1, 2024

(54) METHODS AND SYSTEMS FOR DELIVERING EDGE-ASSISTED ATTENTION-AWARE HIGH DEFINITION MAP

(71) Applicant: Toyota Motor Engineering & Manufacturing North America, Inc., Plano, TX (US)

(72) Inventors: Dawei Chen, Mountain View, CA (US); Haoxin Wang, Mountain View, CA (US); Kyungtae Han, Mountain View, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/877,104

(22) Filed: Jul. 29, 2022

(51) Int. Cl. G01C 21/34; G06V 20/59; B60W 60/00

(52) U.S. Cl. CPC G01C 21/3415; G01C 21/3484; G06V 20/597; B60W 60/0011; B60W 2540/225

(57) ABSTRACT

An edge device for providing an HD map to a vehicle is provided. The edge device includes a controller programmed to: obtain a head pose of an occupant of a vehicle; obtain a location of the vehicle following an original route; analyze the head pose and the location of the vehicle to determine a potential route for the vehicle, the potential route being different from the original route, and transmit HD map information corresponding to the potential route to the vehicle in response to determining the potential route.

### TECHNICAL FIELD

The present disclosure relates to a high definition (HD) map delivery system, and more particularly, to methods and systems for delivering the HD map to a vehicle based on the attention of a driver of the vehicle.

### BACKGROUND

A high-definition (HD) map is a highly accurate map used in autonomous driving. The HD map contains details not normally present on traditional maps. Downloading or caching a whole city-level HD map is not practical because the storage of vehicle is limited. One effective and common way is to pre-load or cache the HD map for a planned path. Conventional systems mainly consider how to optimize the path from the current location to a destination and pre-load the corresponding part of HD map to the autonomous vehicle.

However, on the way, the driver may change his mind to another destination or add stops before arrival of the original destination. Therefore, systems and methods for identifying a changed route and downloading the HD map corresponding to the changed route in advance are desired.

### SUMMARY

According to one embodiment of the present disclosure, an edge device for providing an HD map to a vehicle is provided. The edge device includes a controller programmed to: obtain a head pose of an occupant of a vehicle; obtain a location of the vehicle following an original route; analyze the head pose and the location of the vehicle to determine a potential route for the vehicle, the potential route being different from the original route, and transmit HD map information corresponding to the potential route to the vehicle in response to determining the potential route.

According to another embodiment of the present disclosure, a system for delivering an HD map is provided. The system includes a vehicle and an edge device. The vehicle includes a first controller programmed to: monitor a head pose of an occupant of the vehicle; determine whether the head pose deviates from a default path for a predetermined period of time; and transmit the head pose and a location of the vehicle to an edge device in response to determining that the head pose deviates from the default path for the predetermined time. The edge device includes a second controller programmed to: analyze the head pose and the location of the vehicle to determine a potential route for the vehicle, the potential route being different from the original route; and transmit HD map information corresponding to the potential route in response to determining the potential route.

According to another embodiment of the present disclosure, a method for delivering an HD map is provided. The method includes estimating a head pose of an occupant of a vehicle; obtaining a location of the vehicle following an original route; analyzing the head pose and the location of the vehicle to determine a potential route for the vehicle, the potential route being different from the original route; and transmitting HD map information corresponding to the potential route to the vehicle in response to determining the potential route for the vehicle.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIGS. 1A and 1B depict an example scenario where a system analyzes the head pose of a driver to identify a potential route different from an original route, according to one or more embodiments shown and described herein;

FIG. 2 depicts a schematic diagram of an example system, according to one or more embodiments shown and described herein;

FIG. 3 depicts a system block diagram for providing an HD map for a potential route, according to one or more embodiments shown and described herein;

FIG. 4 depicts a system sequence chart, according to one or more embodiments shown and described herein; and

FIG. 5 depicts an example of a HD map that a vehicle uses for autonomous driving, according to one or more embodiments shown and described herein.

### DETAILED DESCRIPTION

The present disclosure provides a system for delivering an HD map to a vehicle. The system includes a vehicle and an edge device. The vehicle monitors a head pose of an occupant of the vehicle, determines whether the head pose deviates from a default path for a predetermined period of time, and transmits the head pose and a current location of the vehicle to an edge device in response to determining that the head pose deviates from the default path for the predetermined time. The edge device analyzes the head pose and the location of the vehicle to determine a potential route for the vehicle. The potential route is different from the original route. The edge device transmits HD map information corresponding to the potential route in response to determining the potential route. Because the edge device distributes the HD map corresponding to the potential map to the vehicle in a low-latency manner, the vehicle may drive autonomously using the HD map even when the vehicle changes its route from the original route to the potential route.

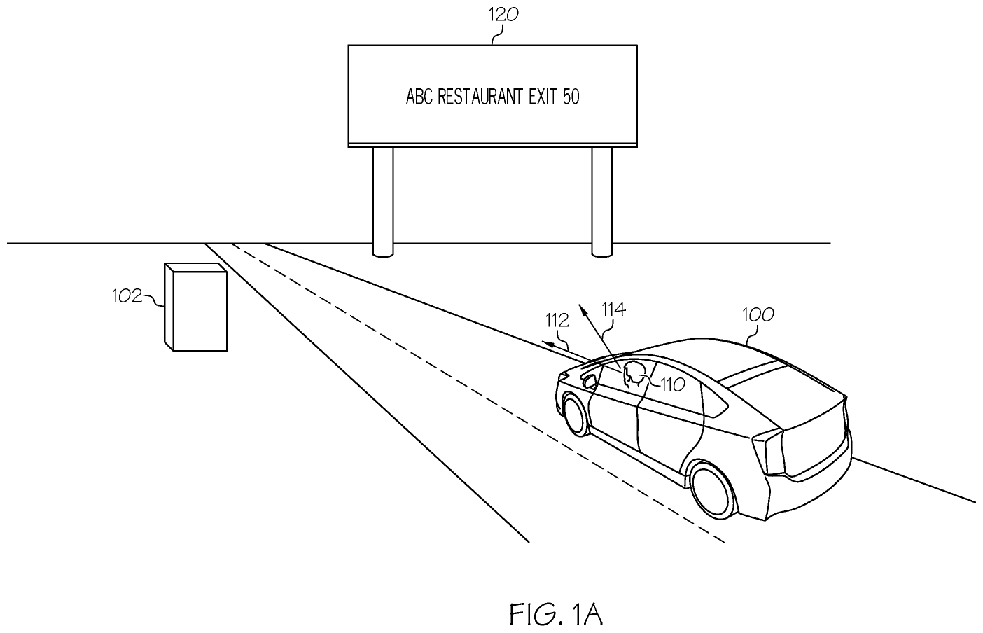

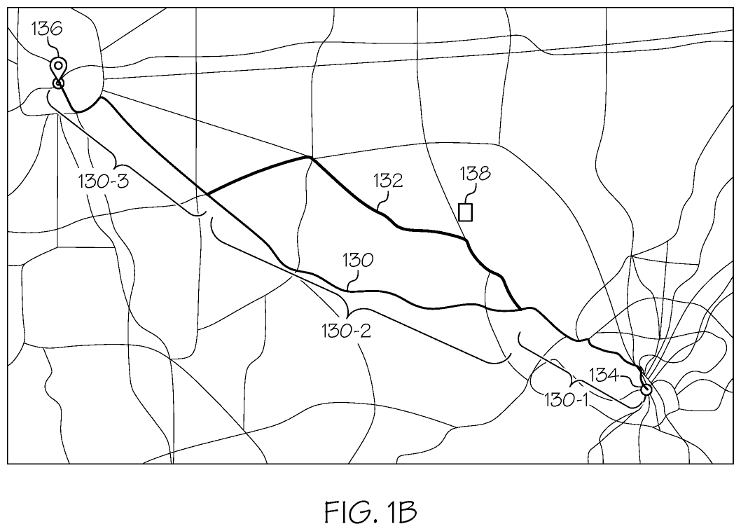

FIGS. 1A and 1B depict an example scenario where a system analyzes the head pose of a driver to identify a potential route different from an original route, according to one or more embodiments shown and described herein. The system may include a vehicle 100 and an edge device 102.

The vehicle 100 may be a vehicle including an automobile or any other passenger or non-passenger vehicle such as, for example, a terrestrial, aquatic, and/or airborne vehicle. In embodiments, the vehicle 100 may be an autonomous driving vehicle. In some embodiment, the vehicle 100 may be an unmanned aerial vehicle (UAV), commonly known as a drone.

The vehicle 100 may contain one or more driving assist components (e.g., autonomous driving, CACC, etc.) and one or more radios to communicate with other vehicles and/or infrastructure. The vehicle 100 may establish wireless connectivity with the edge device 102 and/or other infrastructure such as a cloud server. The vehicle 100 may autonomously drive following a route to a destination. For example, the vehicle 100 may autonomously follow a route 130 starting from a point of departure 134 to a destination 136 as illustrated in FIG. 1B.

In embodiments, the vehicle 100 may download a HD map corresponding to the route 130 in advance. For example, the vehicle 100 may download the HD map corresponding to the route 130 before the vehicle 100 starts driving from the point of departure 134. As another example, the vehicle 100 may download portions of the HD map corresponding to the route 130 as the vehicle 100 progresses. Specifically, the vehicle 100 may download portions of the HD map corresponding to a subsection 130-1 before the vehicle 100 starts driving from the point of departure 134. Then, while driving in the subsection 130-1, the vehicle 100 may download portions of the HD map corresponding to a subsection 130-2. Similarly, while driving in the subsection 130-2, the vehicle 100 may download portions of the HD map corresponding to a subsection 130-3.

The vehicle 100 may monitor a head pose of an occupant 110 using sensors, for example, an in-vehicle camera. The occupant 110 may be a driver or a passenger of the vehicle 100. For example, the head pose of the occupant 110 indicates that the occupant 110 faces toward a forward direction 112 corresponding to the driving direction of the vehicle 100. The occupant 110 may change her head pose and look at a billboard 120 for a certain period of time, for example, few seconds. In this case, the occupant 110 faces toward a direction 114 directed from the vehicle 100 to the billboard 120. Then, the vehicle may determine a potential route for the vehicle 100 based on the changed head pose. Specifically, the vehicle 100 may obtain information about the billboard 120 and determine a potential route that is different from the original route 130. Specifically, the vehicle 100 may capture an image of the billboard 120 using one or more sensors of the vehicle 100 and process the image to obtain information about advertisements on the billboard 120. For example, the vehicle 100 may identify ABC restaurant in the billboard 120 and retrieve the location of ABC restaurant. Then, the vehicle 100 may determine a potential route based on the location of ABC restaurant. For example, the potential route may be the route 132 illustrated in FIG. 1B. The route 132 is an alternative route to the destination 136, but includes the location of ABC restaurant 138 as illustrated in FIG. 1B. In some embodiments, the vehicle 100 may determine more than one potential route.

Once the potential route is determined, the vehicle 100 requests a part of HD map that corresponds to the potential route 132, which is not currently stored in the vehicle 100. The vehicle 100 may request the part of HD map from the edge device 102 or from a remoter server before it reaches the starting point of the potential route 132. Then, the edge device 102 or the remoter server transmits the part of the HD map to the vehicle 100 in a low latency way. The vehicle 100 may store the HD map corresponding to the potential route 132 in its database in addition to the HD map corresponding to the route 130. In some embodiments, the vehicle 100 may store the HD map corresponding to the potential route 132 but delete the HD map corresponding to the portion 130-2 such that the vehicle 100 stores the HD map corresponding to the portions 130-1 and 130-3 and the HD map corresponding to the potential route 132. Accordingly, the autonomous driving mode of the vehicle 100 may be sustainable to guide the occupant 110 of the vehicle for the potential route 132.

The edge device 102 is a computing device or a road side unit that may be positioned within a communication distance of the vehicle 100. In some embodiments, the edge device 102 may be a moving server, such as another vehicle, a cloud-based server, or any other type of computing device. The edge device 102 may be communicatively coupled to the vehicle 100 via wireless connectivity. The edge device 102 may store an HD map covering certain areas or routes. If the edge device 102 stores the part of HD map that is requested by the vehicle, the edge device 102 may transmit the part of HD map to the vehicle 100. For example, by referring to FIG. 1B, while the vehicle 100 is driving within the subsection 130-1, the vehicle 100 determines the potential route 132 based on the head pose of the occupant 110. The edge device 102 may receive a request for the part of HD map corresponding to the potential route 132 from the vehicle 100. If the edge device 102 stores the part of HD map corresponding to the potential route 132, the edge device 102 transmits the part of HD map corresponding to the potential route 132 to the vehicle 100. If the edge device 102 stores the part of HD map corresponding to the potential route 132, the edge device 102 may request the part of HD map corresponding to the potential route 132 from a remote server.

While FIG. 1A illustrates that the vehicle 100 communicates with the edge device 102, the vehicle 100 may wirelessly communicate with a remote server, which may be a cloud-based server. The vehicle 100 may receive an HD map directly from the remote server. In some embodiment, the vehicle 100 may receive the HD map from other vehicles who store the corresponding HD map and are within a communication range of the vehicle 100.

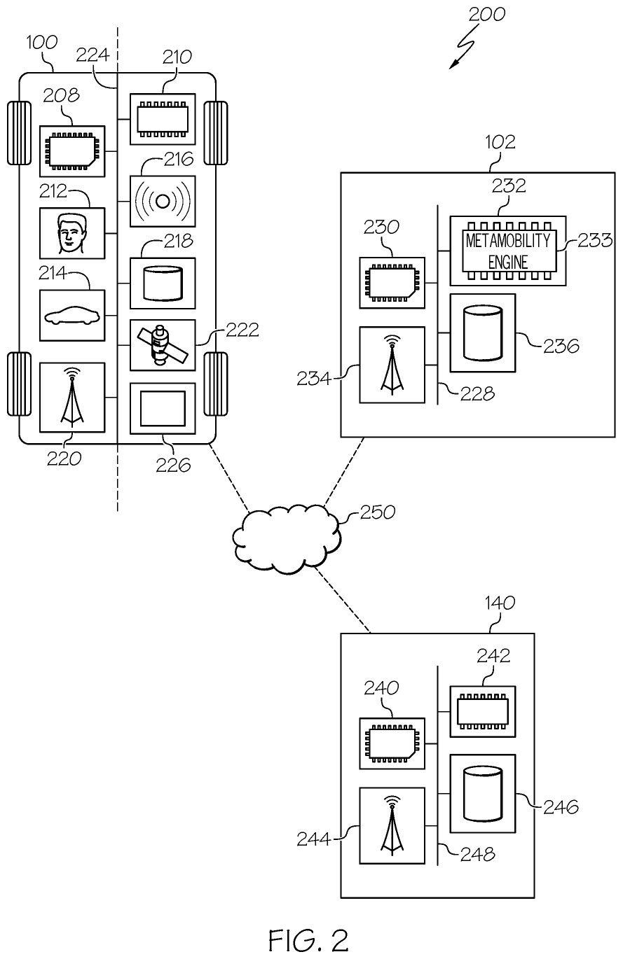

Referring now to FIG. 2, a schematic diagram of an example system 200 is depicted. In particular, the vehicle 100, the edge device 102, and a server 140 are depicted. The vehicle 100 may include a processor component 208, a memory component 210, a user gaze monitoring component 212, a driving assist component 214, a sensor component 216, a vehicle connectivity component 218, a communication module 220, a satellite component 222, and an interface 226. The vehicle 100 also may include a communication path 224 that communicatively connects the various components of the vehicle 100.

The processor component 208 may include one or more processors that may be any device capable of executing machine readable and executable instructions. Accordingly, each of the one or more processors of the processor component 208 may be a controller, an integrated circuit, a microchip, or any other computing device. The processor component 208 is coupled to the communication path 224 that provides signal connectivity between the various components of the connected vehicle. Accordingly, the communication path 224 may communicatively couple any number of processors of the processor component 208 with one another and allow them to operate in a distributed computing environment. Specifically, each processor may operate as a node that may send and/or receive data. As used herein, the phrase “communicatively coupled” means that coupled components are capable of exchanging data signals with one another such as, e.g., electrical signals via a conductive medium, electromagnetic signals via air, optical signals via optical waveguides, and the like.

Accordingly, the communication path 224 may be formed from any medium that is capable of transmitting a signal such as, e.g., conductive wires, conductive traces, optical waveguides, and the like. In some embodiments, the communication path 224 may facilitate the transmission of wireless signals, such as Wi-Fi, Bluetooth®, Near-Field Communication (NFC), and the like. Moreover, the communication path 224 may be formed from a combination of mediums capable of transmitting signals. In one embodiment, the communication path 224 comprises a combination of conductive traces, conductive wires, connectors, and buses that cooperate to permit the transmission of electrical data signals to components such as processors, memories, sensors, input devices, output devices, and communication devices. Accordingly, the communication path 224 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The memory component 210 is coupled to the communication path 224 and may contain one or more memory modules comprising RAM, ROM, flash memories, hard drives, or any device capable of storing machine readable and executable instructions such that the machine readable and executable instructions can be accessed by the processor component 208. The machine readable and executable instructions may comprise logic or algorithms written in any programming language of any generation (e.g., 1GL, 2GL, 3GL, 4GL, or 5GL) such as, e.g., machine language, that may be directly executed by the processor, or assembly language, object-oriented languages, scripting languages, microcode, and the like, that may be compiled or assembled into machine readable and executable instructions and stored on the memory component 210. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory component 210 may include an HD map for autonomous driving of the vehicle 100.

The vehicle 100 may also include a user gaze monitoring component 212. The user gaze monitoring component 212 may include imaging sensors such as a camera or an infrared (IR) blaster. The data gathered by the user gaze monitoring component 212 may be analyzed by the processor component 208 to determine whether the direction of the user's gaze is in the direction of the motion of the vehicle 100 or elsewhere. For example, by referring to FIG. 1A, the user gaze monitoring component 212 may determine that the occupant 110 faces toward the billboard 120. This analysis may be based on the user's head position, eye position, etc. In some embodiments, the vehicle 100 may transmit the data gathered by the user gaze monitoring component 212 to the edge device 102, and the processor 230 of the edge device 102 may analyze the data to determine whether the direction of the user's gaze is in the direction of the motion of the vehicle 100 or elsewhere.

The vehicle 100 may also include a driving assist component 214, and the data gathered by the sensor component 216 may be used by the driving assist component 214 to assist the navigation of the vehicle. The data gathered by the sensor component 216 may also be used to perform various driving assistance including, but not limited to advanced driver-assistance systems (ADAS), adaptive cruise control (ACC), cooperative adaptive cruise control (CACC), lane change assistance, anti-lock braking systems (ABS), collision avoidance system, automotive head-up display, and the like. The information exchanged between vehicles may include information about a vehicle's speed, heading, acceleration, and other information related to a vehicle state.

The vehicle 100 also comprises the sensor component 216. The sensor component 216 is coupled to the communication path 224 and communicatively coupled to the processor component 208. The sensor component 216 may include, e.g., LiDAR sensors, RADAR sensors, optical sensors (e.g., cameras), laser sensors, proximity sensors, location sensors (e.g., GPS modules), and the like. In embodiments, the sensor component 216 may monitor the surroundings of the vehicle and may detect other vehicles and/or traffic infrastructure.

The vehicle 100 also comprises a communication module 220 that includes network interface hardware for communicatively coupling the vehicle 100 to the edge device 102 or a server 140. The communication module 220 can be communicatively coupled to the communication path 224 and can be any device capable of transmitting and/or receiving data via a network or other communication mechanisms. Accordingly, the communication module 220 can include a communication transceiver for sending and/or receiving any wired or wireless communication. For example, the network interface hardware of the communication module 220 may include an antenna, a modem, a LAN port, a Wi-Fi card, a WiMAX card, a cellular modem, near-field communication hardware, satellite communication hardware, and/or any other wired or wireless hardware for communicating with other networks and/or devices.

The vehicle 100 also comprises a vehicle connectivity component 218 that includes network interface hardware for communicatively coupling the vehicle 100 to other connected vehicles. The vehicle connectivity component 218 can be communicatively coupled to the communication path 224 and can be any device capable of transmitting and/or receiving data via a network or other communication mechanisms. Accordingly, the vehicle connectivity component 218 can include a communication transceiver for sending and/or receiving any wired or wireless communication. For example, the network interface hardware of the vehicle connectivity component 218 may include an antenna, a modem, a LAN port, a Wi-Fi card, a WiMAX card, a cellular modem, near-field communication hardware, satellite communication hardware, and/or any other wired or wireless hardware for communicating with other networks and/or devices.

The vehicle 100 may connect with one or more other connected vehicles and/or external processing devices (e.g., the edge device 102) via a direct connection. The direct connection may be a vehicle-to-vehicle connection (“V2V connection”) or a vehicle-to-everything connection (“V2X connection”). The V2V or V2X connection may be established using any suitable wireless communication protocols discussed above. A connection between vehicles may utilize sessions that are time and/or location-based. In embodiments, a connection between vehicles or between a vehicle and an infrastructure may utilize one or more networks to connect which may be in lieu of, or in addition to, a direct connection (such as V2V or V2X) between the vehicles or between a vehicle and an infrastructure. By way of a non-limiting example, vehicles may function as infrastructure nodes to form a mesh network and connect dynamically/ad-hoc. In this way, vehicles may enter/leave the network at will such that the mesh network may self-organize and self-modify over time. Other non-limiting examples include vehicles forming peer-to-peer networks with other vehicles or utilizing centralized networks that rely upon certain vehicles and/or infrastructure. Still other examples include networks using centralized servers and other central computing devices to store and/or relay information between vehicles.

A satellite component 222 is coupled to the communication path 224 such that the communication path 224 communicatively couples the satellite component 222 to other modules of the vehicle 100. The satellite component 222 may comprise one or more antennas configured to receive signals from global positioning system satellites. Specifically, in one embodiment, the satellite component 222 includes one or more conductive elements that interact with electromagnetic signals transmitted by global positioning system satellites. The received signal is transformed into a data signal indicative of the location (e.g., latitude and longitude) of the satellite component 222, and consequently, the vehicle 100.

The vehicle 100 may also include a data storage component that may be included in the memory component 210. The data storage component may store data used by various components of the vehicle 100. In addition, the data storage component may store data gathered by the sensor component 216, received from the edge device 102, and/or received from other vehicles. The data storage component may include a HD map for autonomous driving of the vehicle 100.

The connected vehicle 106 may also include an interface 226. The interface 226 may allow for data to be presented to a human driver and for data to be received from the driver. For example, the interface 226 may include a screen to display information to a driver, speakers to present audio information to the driver, and a touch screen that may be used by the driver to input information. The interface 226 may display a current route of the vehicle 100 or an HD map.

In some embodiments, the vehicle 100 may be communicatively coupled to the edge device 102 by a network 250. The network 250 may be a wide area network, a local area network, a personal area network, a cellular network, a satellite network, and the like.

The edge device 102 comprises a processor 230, a memory component 232, a communication module 234, a database 236, and a communication path 228. Each server component is similar in features to its connected vehicle counterpart, described in detail above (e.g., the processor 230 corresponds to the processor component 208, the memory component 232 corresponds to the memory component 210, the communication module 234 corresponds to the communication module 220, the database 236 corresponds to the database in the memory component 210, and the communication path 228 corresponds to the communication path 224). The memory component 232 may store a metamobility engine module 233. The metamobility engine module 233 may be a program module in the form of operating systems, application program modules, and other program modules stored in the memory component 232.

The metamobility engine module 233 may be a program configured to analyze a head pose of the occupant of the vehicle 100 and the location of the vehicle 100 received from the vehicle 100 and determine potential routes that are different from the original route of the vehicle 100.

The server 140 includes one or more processors 240, one or more memory modules 242, a communication module 244, a data storage component 246, and a communication path 248. The components of the server 140 may be structurally similar to and have similar functions as the corresponding components of the edge device 102 (e.g., the one or more processors 240 corresponds to the processor 230, the one or more memory modules 242 corresponds to the memory component 232, the communication module 244 corresponds to the communication module 234, the data storage component 246 corresponds to the database 236, and the communication path 248 corresponds to the communication path 228).

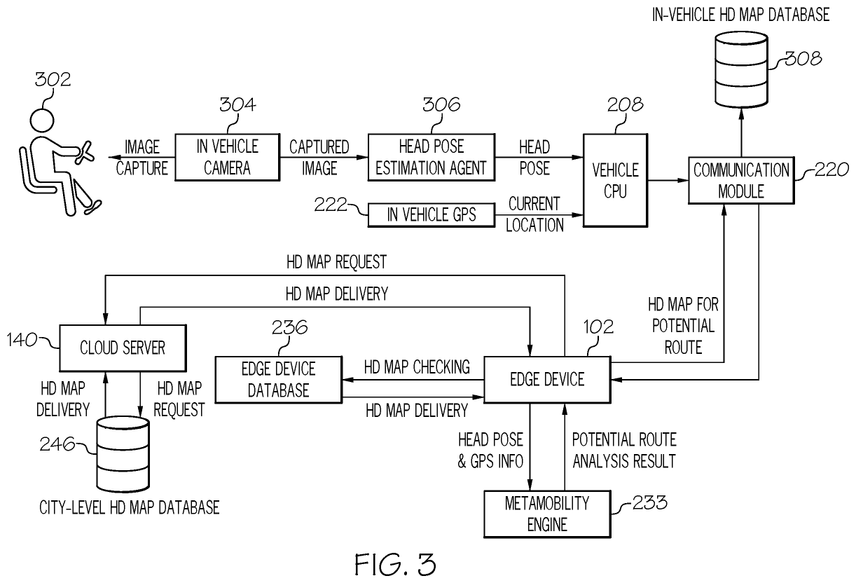

Referring now to FIG. 3, a system block diagram for providing an HD map for a potential route is depicted. An in-vehicle camera 304 monitors and captures a head pose of a driver 302 of a vehicle. The in-vehicle camera 304 may correspond to the sensor component 216 in FIG. 2. The in-vehicle camera 304 transmits the captured image to a head pose estimation agent 306. The head pose estimation agent 306 analyzes the captured image to obtain a head pose and transmits the head pose to the processor component 208, or a vehicle CPU. The satellite component 222, or in-vehicle GPS, obtains the current location of the vehicle and transmits the current location to the vehicle CPU 208. The vehicle CPU 208 transmits the head pose of the driver and the current location of the vehicle to the edge device 102 via the communication module 220.

The processor of the edge device 102 transmits the head pose of the driver and the current location of the vehicle to the metamobility engine module 233. The metamobility engine module 233 may be a machine learning model that receives a head pose and a location of a vehicle as inputs and outputs a potential route for the vehicle. The metamobility engine module 233 may be trained based on actual data including the routes of vehicles, head poses of occupants of the vehicles, locations of the vehicles when head poses change occur, and the like. The metamobility engine module 233 analyzes the head pose of the driver and the current location of the vehicle and determines a potential route that is different from the original route of the vehicle. For example, by referring to FIGS. 1A and 1B, the vehicle 100 may transmit the head pose of the occupant 110 and the current location of the vehicle 100 to the edge device 102. The metamobility engine module 233 of the edge device 102 may determine that the occupant 110 looked at the billboard 120 based on the head pose of the occupant 110 and the current location of the vehicle 100. Then, the metamobility engine module 233 of the edge device 102 may obtain information about advertisements on the billboard 120. The information about the advertisements on the billboard 120 may be stored in the edge device. Alternatively, the edge device 102 may receive the information about the advertisements on the billboard 120 from the vehicle 100. Based on the information about advertisements, e.g., the location of a place being advertised, the metamobility engine module 233 of the edge device 102 may determine potential route for the vehicle 100, e.g., the route 132 in FIG. 1B.

In another example, the occupant of the vehicle may look at a certain location on a map being displayed on the screen of the vehicle. For example, the map illustrated in FIG. 1B may be displayed on the interface 226 of the vehicle 100. The head pose of the occupant of the vehicle may be directed to an icon 138 for a certain period of time, e.g., few seconds. The original route of the vehicle is the route 130. Then, based on the head pose of the occupant, the metamobility engine module 233 of the edge device 102 may determine the potential route 132.

In some embodiments, the metamobility engine module 233 may also consider facial expression of the occupant of the vehicle when determining a potential route. For example, the in-vehicle camera 304 captures an image of the face of the driver 302 of the vehicle, and the vehicle CPU 208 may process the image of the face of the driver 302 to identify facial expression of the driver 302. The vehicle CPU 208 may transmit information about the facial expression of the driver 302 to the edge device 102. The metamobility engine module 233 may analyze the head pose of the driver, the current location of the vehicle, and the facial expression of the driver to determine a potential route. For example, by referring to FIGS. 1A and 1B, the vehicle 100 may transmit the head pose of the occupant 110, the current location of the vehicle 100 to the edge device 102, and the facial expression of the occupant 110 when the occupant 110 faces toward the billboard 120. If the facial expression of the occupant 110 is a positive facial expression, such as smiling, the metamobility engine module 233 of the edge device 102 may obtain information about advertisements on the billboard 120. Based on the information about advertisements, e.g., the location of a place being advertised, the metamobility engine module 233 of the edge device 102 may determine potential route for the vehicle 100, e.g., the route 132 in FIG. 1B. If the facial expression of the occupant 110 is a negative facial expression, such as anger, disgust, fear, or sadness, the metamobility engine module 233 of the edge device 102 may determine that no potential route is desired for the vehicle.

The processor of the edge device 102 determines whether the database 236 of the edge device 102 stores an HD map corresponding to the potential route. If the database 236 of the edge device 102 stores the HD map corresponding to the potential route, the edge device 102 transmits the HD map corresponding to the potential route to the communication module 220 of the vehicle and the vehicle stores the received HD map corresponding to the potential route in the database 308 of the vehicle. The transmission of the HD map corresponding to the potential route occurs before the vehicle starts following the potential route that is different from the original route.

If the database 236 of the edge device 102 does not store the HD map corresponding to the potential route, the edge device 102 transmits a request for the HD map corresponding to the potential route to a cloud server 140. The cloud server 140 retrieves the HD map corresponding to the potential route from an HD map database, for example, a city-level HD map database and transmits the retrieved HD map corresponding to the potential route to the edge device 102. Then, the edge device 102 transmits the HD map corresponding to the potential route to the edge device 102 to the communication module 220 of the vehicle and the vehicle stores the received HD map corresponding to the potential route in the database 308 of the vehicle. The transmission of the HD map corresponding to the potential route occurs before the vehicle starts following the potential route that is different from the original route, for example, before driving the route 132 in FIG. 1B.

In some embodiments, the metamobility engine module 233 may be included in the vehicle and the vehicle may determine a potential route based on the head pose of the driver and the current location of the vehicle. Then, the vehicle determines whether an HD map corresponding to the potential route is stored in the database 308 of the vehicle. If the HD map corresponding to the potential route is stored in the database 308 of the vehicle, the vehicle continues to autonomously drive based on the HD map stored in the database. If the HD map corresponding to the potential route is not stored in the database 308 of the vehicle, the vehicle may request for the HD map corresponding to the potential route to the edge device 102.

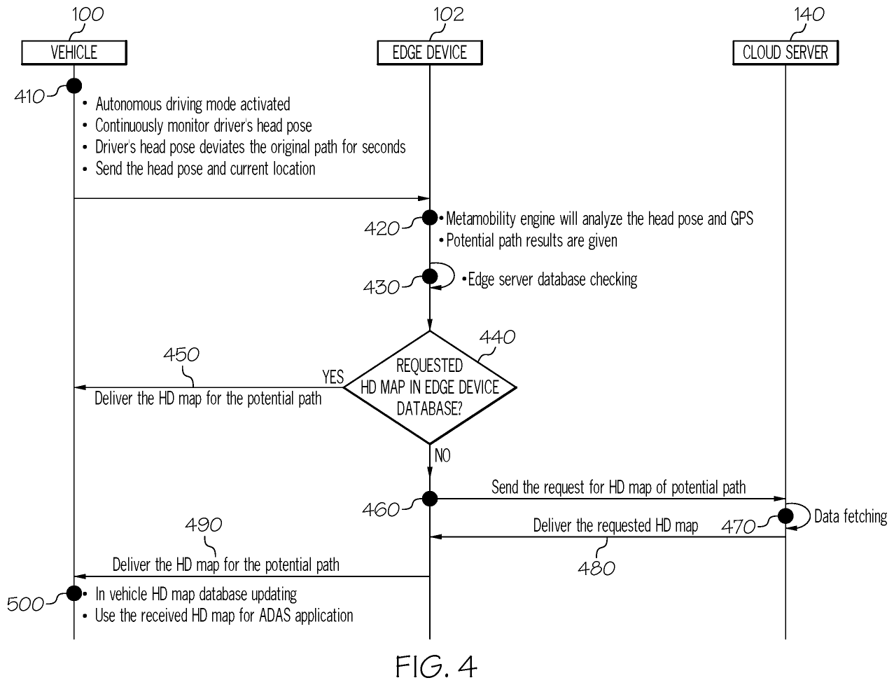

FIG. 4 depicts a system sequence chart, according to one or more embodiments shown and described herein.

In step 410, the vehicle 100 is driving autonomously. The vehicle 100 continuously monitors the driver's head pose using sensors, such as an in-vehicle camera. The controller of the vehicle 100 may determine whether the head pose deviates from an original or default pose for a predetermined time, e.g., for few seconds. If it is determined that the head pose deviates from the default pose for the predetermined time, the controller of the vehicle 100 transmits the deviated head pose and the current location of the vehicle to the edge device 102.

In step 420, the metamobility engine of the edge device 102 analyzes the deviated head pose and the current location of the vehicle to obtain a potential route for the vehicle. The potential route for the vehicle is different from the original route of the vehicle, and the vehicle may not store an HD map corresponding to the potential route. Specifically, the controller of the edge device 102 obtains information about an object that the occupant of the vehicle faces based on the deviated head pose and the location of the vehicle. The object may be a billboard, a road sign, or a point of interest on a map displayed on an in-vehicle screen and it is determined that the occupant of the vehicle faces the billboard or the road sign based on the head pose of the occupant and the location of the vehicle. For example, by referring to FIG. 1A, the controller of the edge device 102 determines that the occupant 110 of the vehicle 100 faces the billboard 120 based on the head pose in the direction 114 and the current location of the vehicle 100.

Then, the controller of the edge device 102 determines a potential route for the vehicle based on the information about the object and the original route. For example, by referring to FIG. 1A, the controller of the edge device 102 may obtain the location of a place advertised on the billboard 120. The location of the entity advertised on the billboard 120 may be stored in the database of the edge device 102. As another example, the edge device 102 may receive the location of the place advertised on the billboard 120 from the vehicle 100. Specifically, the vehicle 100 may capture the image of the billboard 120, process the image to identify the entity advertised on the billboard, and transmit the location of the entity to the edge device 102. The controller of the edge device 102 may determine the potential route for the vehicle based on the location of the place and the original route. For example, by referring to FIGS. 1A and 1B, the location of ABC restaurant advertised on the billboard 120 is not along the original route 130. The map in FIG. 1B indicates the location of ABC restaurant 138. Then, the controller of the edge device 102 may determine the route 132 as the potential route or the changed route that accommodates the occupant 110's interest in ABC restaurant.

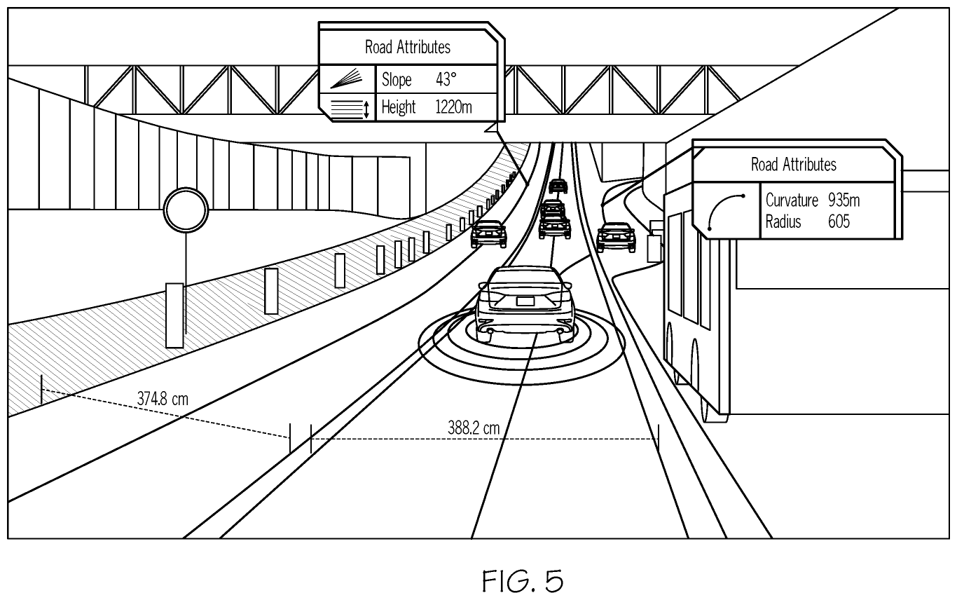

Referring back to FIG. 4, in step 430, the edge device 102 determines whether the HD map corresponding to the potential route is stored in the database of the edge device 102. If it is determined that the HD map corresponding to the potential route is stored in the database of the edge device 102, the edge device 102 transmits the HD map corresponding to the potential route to the vehicle 100 in step 440. If it is determined that the HD map corresponding to the potential route is not stored in the database of the edge device 102, the edge device 102 sends a request for the HD map corresponding to the potential route to the cloud server 140 in step 450. In step 460, the cloud server fetches the HD map corresponding to the potential route from the database of the cloud server 140. In step 470, the cloud server 140 transmits the fetched HD map corresponding to the potential route to the edge device 102. Then, the edge device 102 transmits the HD map corresponding to the potential route to the vehicle 100 in step 480. In step 490, the vehicle 100 updates its HD map database based on the received HD map corresponding to the potential route and uses the received HD map for ADAS application when filing the potential route. FIG. 5 is an example of a HD map that the vehicle 100 uses for autonomous driving while filing the potential route.

The present disclosure provides an edge device that obtains a head pose of an occupant of a vehicle, obtains a location of the vehicle following an original route, analyzes the head pose and the location of the vehicle to determine a potential route for the vehicle, the potential route being different from the original route, and transmits HD map information corresponding to the potential route to the vehicle in response to determining the potential route. Because the edge device provides an HD map corresponding to the potential route to a vehicle before the vehicle drives on the potential route, the vehicle may utilize the HD map corresponding to the potential route without a significant delay in downloading the HD map corresponding to potential route.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An edge device comprising:
a controller programmed to:
obtain a head pose of an occupant of a vehicle;
obtain a location of the vehicle following an original route;
analyze the head pose and the location of the vehicle to determine a potential route for the vehicle, the potential route being different from the original route; and
transmit HD map information corresponding to the potential route to the vehicle in response to determining the potential route.

2. The edge device of claim 1, wherein the controller is further configured to:
transmit the HD map information to the vehicle prior to the vehicle driving in the potential route.

3. The edge device of claim 1, wherein the controller is further configured to:
obtain information about an object that the occupant faces based on the head pose; and
determine the potential route for the vehicle based on the information about the object and the original route.

4. The edge device of claim 3, wherein the object is a billboard or a road sign, and
the controller is further configured to:
obtain a location of a place shown in the billboard or the road sign; and
determine the potential route for the vehicle based on the location of the place and the original route.

5. The edge device of claim 1, wherein the controller is further configured to:
determine whether the HD map information corresponding to the potential route is stored in a database of the edge device;
transmit a request for the HD map information corresponding to the potential route to a cloud server in response to determining that the HD map information corresponding to the potential route is not stored in the database.

6. The edge device of claim 1, wherein the HD map information includes information for autonomous driving of the vehicle.

7. The edge device of claim 6, wherein the information for autonomous driving of the vehicle includes locations of objects, lane markings, and road signs.

8. The edge device of claim 1, wherein the HD map information includes information about stores and advertisements.

9. The edge device of claim 1, wherein the controller is programmed to:
obtain a facial expression of the occupant of the vehicle; and
analyze the head pose, the location of the vehicle, and the facial expression to determine the potential route for the vehicle.

10. A system for delivering an HD map, the system comprising:
a vehicle comprising a first controller programmed to:
monitor a head pose of an occupant of the vehicle;
determine whether the head pose deviates from a default path for a predetermined period of time; and
transmit the head pose and a location of the vehicle to an edge device in response to determining that the head pose deviates from the default path for the predetermined time; and
the edge device comprising a second controller programmed to:
analyze the head pose and the location of the vehicle to determine a potential route for the vehicle, the potential route being different from the original route; and
transmit HD map information corresponding to the potential route in response to determining the potential route.

11. The system of claim 10, wherein the second controller is further configured to:
transmit the HD map information to the vehicle prior to the vehicle driving in the potential route.

12. The system of claim 10, wherein the second controller is further configured to:
obtain information about an object that the occupant faces based on the head pose and the location of the vehicle; and
determine the potential route for the vehicle based on the information about the object and the original route.

13. The system of claim 12, wherein the object is a billboard or a road sign, and
the second controller is further configured to:
obtain a location of a place shown in the billboard or the road sign; and
determine the potential route for the vehicle based on the location of the place and the original route.

14. The system of claim 10, wherein the second controller is further configured to:
determine whether the HD map information corresponding to the potential route is stored in a database of the edge device; and
transmit a request for the HD map information corresponding to the potential route to a cloud server in response to determining that the HD map information corresponding to the potential route is not stored in the database.

15. The system of claim 10, wherein the first controller is further configured to:
obtain information about an object that the occupant faces based on the head pose; and
determine the potential route for the vehicle based on the information about the object and the original route.

16. A method for delivering an HD map, the method comprising:
estimating a head pose of an occupant of a vehicle;
obtaining a location of the vehicle following an original route;
analyzing the head pose and the location of the vehicle to determine a potential route for the vehicle, the potential route being different from the original route; and
transmitting HD map information corresponding to the potential route to the vehicle in response to determining the potential route for the vehicle.

17. The method of claim 16, further comprising:
obtaining information about an object that the occupant faces based on the head pose; and
determining the potential route for the vehicle based on the information about the object and the original route.

18. The method of claim 17, wherein the object is a billboard or a road sign, and
the method further comprises:
obtaining a location of a place shown in the billboard or the road sign; and
determining the potential route for the vehicle based on the location of the place and the original route.

19. The method of claim 16, further comprising:
determining whether the HD map information corresponding to the potential route is stored in a database of the edge device; and
transmitting a request for the HD map information corresponding to the potential route to a cloud server in response to determining that the HD map information corresponding to the potential route is not stored in the database.

20. The method of claim 16, wherein the HD map information corresponding to the potential route is transmitted to the vehicle before the vehicle drives in the potential route.
